(19) United States
(12) Patent Application Publication
(10) Pub. No.: US 2005/0134098 A1
(43) Pub. Date: Jun. 23, 2005

(54) Motorcycle utility platform

(76) Inventor: Larry Lee MacKeben, Caledonia, IL (US)

Correspondence Address: Larry MacKeben, 3480 Krupke Rd, Caledonia, IL, 61011, US

(21) Appl. No.: 10/734,465

(22) Filed: Dec. 12, 2003

(51) Int. Cl. B60N 2/38

(52) U.S. Cl. 297/195.1

(57) ABSTRACT

Although the size, shape, material and design charctereristics may change for motorcycle make or model, and possibly just for cosmetic appearence. What is claimed is the concept of a weight bearing bracket attached to the frame sufficient for passenger transportation, without touching the finer finishes of the motorcycle. Following the contour of the rear fender of differing shapes. While keeping passenger center of gravity at a minimum for safety and to provide a safer and more comfortable ride through the creation of a backrest bracket feature mounted to a generic sissy bar.

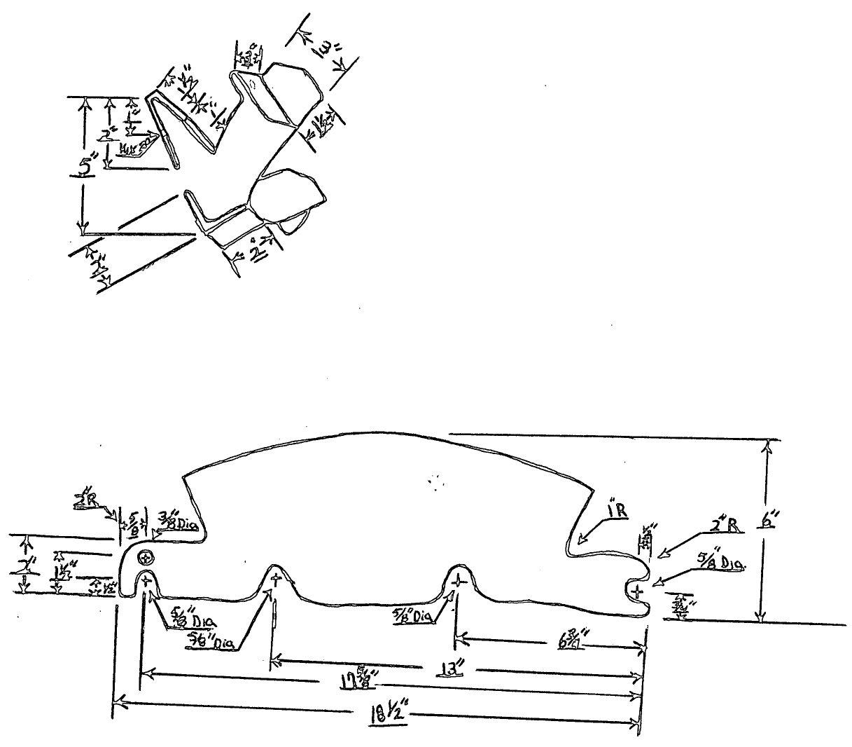

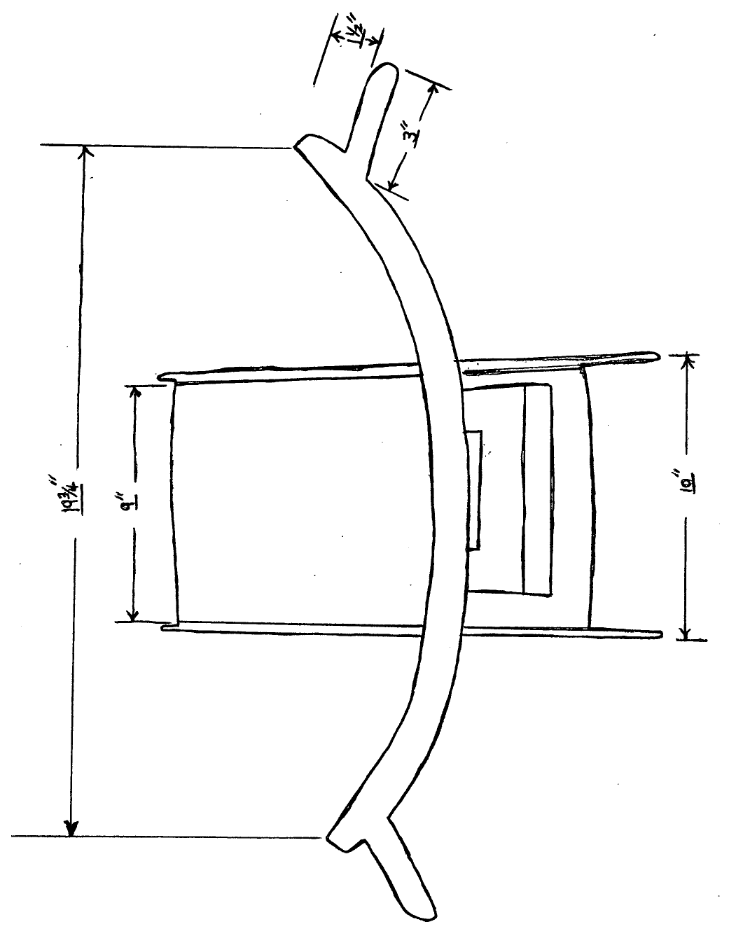

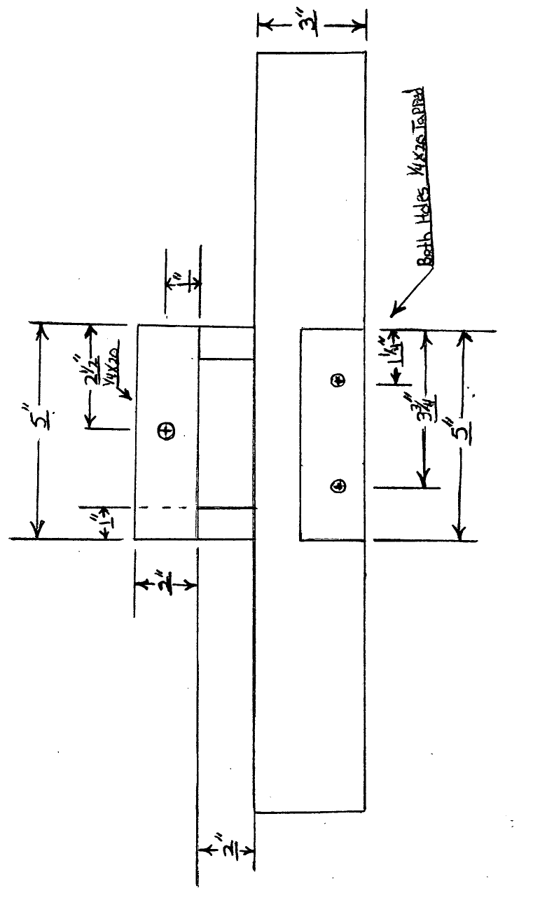

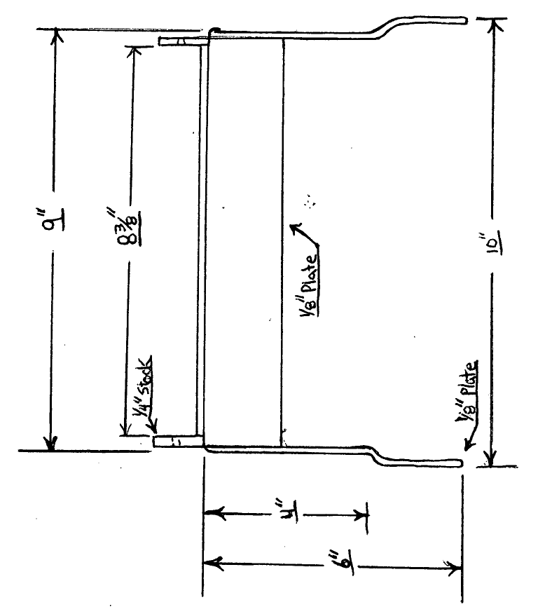

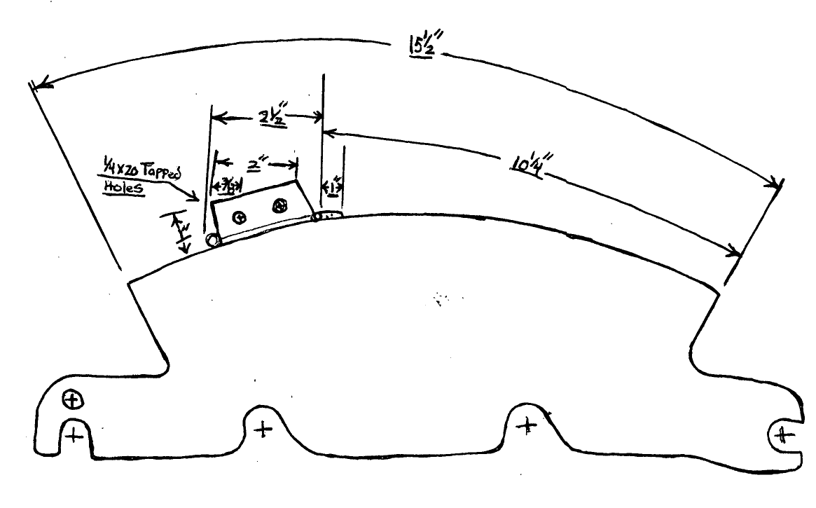

### FIELD OF INVENTION

The present relates generally to platforms, and more particularly relates to a motorcycle utility platforms.

### BACKGROUND OF THE INVENTION

Platforms for motorcycles are known in the art. However, prior art platforms are not designed appropriatly for safety of passenger seating applications and further cause problems with marring of a motorcycle rear fender.

What is needeed is a platform that allows a non-marring application of a passenger seat and provides passenger safety.

### BRIEF SUMMARY OF INVENTION

All prior art utilized renforcement by brackets attached to rear axle. Since the utilization of the swingarm rear suspension, no prior art exists for passenger seating other than attachment and resting on the motorcycle rear fender. Which causes marring of the rear fender.

All prior art lending resemblence to this utility platform typically referred to as luggage racks specifically states “not for use in carrying passengers.” Also expresses a weight restriction resulting in the inability for sufficient passenger accomidation.

This motorcycle utility platform is designed not to touch the rear fender, avoiding the marring of the finish. This utility platform is designed to overcome prior arts lack of load bearing limits and contrived for the express purpose of passenger accomidation or other material handeling capabilities.

The backrest portion of the bracket was added for installation of a passeger backrest of large girth with armrests, creating greater passenger comfort and safety. Prior art only existed in the form of large luggage compartments being utilized for securing such a backrest. No prior art exsisted for securing such a large backrest to a generic sissy bar. This bracket therefore resolves the problem with prior art.

### BRIEF DESCRIPTION OF SEVERAL VIEWS OF DRAWINGS

Page 1 Of 5 Shows the right side view of the main motorcycle platform base with right side of the backrest bracket element elevated in it's normal position with previous art sissy bar not shown.

Page 2 of 5 Shows the base portion and the armrest bracket from a rear elevation.

Page 3 of 5 Shows a rear view of the backrest bracket element.

Page 4 Of 5 Shows the base portion from a rear view, also illustrating the bracket portion of the base that a generic sissy bar mounts to.

Page 5 of 5 Shows again the right side of the base portion to help illustrate the bracket portion used to attach the generic sissy bar.

Also I have included (5) five miscellaneous photographs to aid in drawing identification and to better illustrate the invention and it's application.

### DETAILED DESCRIPTION OF THE INVENTION

Prior to the use of a swingarm rear suspension, prior art brackets would mount to the fender using brackets connecting to a rear axle and frame support. After the use of a swingarm, motorcycle manufacturers mounted passenger seats to the rear fender. Currently, all rear mountings are generally suited for luggage and non-passenger purposes only. The present invention includes a bracket that allows weight bearing loads, such as passengers. The bracket can also be permanently attached for rigid mounting or for quick release.

In another embodiment, a bracket allows for mounting of a touring style armrest seat back to a sissy bar. The current art allows only rigid tourpack styles unacceptable for all makes and models of motorcycles. The enbodiment shown herein conforms to a seat backrest for any sissy bar on most makes and models of motorcycles.

The bracket shown in the drawings attached hereto was constructed in a form that allows for mounting an original pillion passenger seat at the proper angle as close to the motorcycle rear fender as possible without touching.

The platform allows for non-marring application of a passenger seat without ruining the finish of the fender, the platform further allows the seat while not touching the fender to be mounted low enough to provide passenger protection from an optional windshield, and also keeps the rider's center of gravity lower for safety and operator control.

As previously mentioned it also provides for greater ability to distribute passenger weight overall a greater area to provide much larger weight bearing load while minimizing the use of additional brackets that may otherwise be necessary.

The platform is further designed to accommodate accessories such as the golf bag carrier. The contour of the platform following the fender of a motorcycle allows second bracket to start lower. Thus a lower center of gravity is maintained for stability and a greater load may be applied without the aid of cumbersome unsightly brackets and without altering or damaging the original finish of the motorcycle fender. Although design and mounting application may vary slightly between models the premise of contour, form and weight distribution mounting without compromising the integrity of the fender an aspect of the invention.

The platform allows for an armrest touring style seat back bracket and optionally mounting backrests to a sissy bar for comfort and security. Advantageously, the backrest can be used independent of a cumbersome fiberglass tour pack as is known in the prior art.

The platform further allows mounting a comfortable seat back securely to the sissy bar that may remain in place or be removed, but may be done without resorting to a touring bike application.

The only way currently to allow for such a seat back to be mounted is with the hard fiberglass tour pack that is not compatible with all motorcycles. According to an embodiment, the platform allows any motorcycle equipped with a sissy bar to accept a touring style backrest.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifictions as are suited to the particular use contemplated. All such modifications and variations are within the scope of the invention as determined by the appended claims when interpreted in accordance with the breadth to which they are fairly, legally, and equitably entitled.

1. A platform for a motorcycle, the platform comprising: at least two brackets, each bracket including at least two mounts, one of the mounts being coupable to a frame component of the motorcycle; a contoured surface attached to each bracket via at least two arms, the contoured surface following the contour of a motorcycle fender and forming a gap between the motorcycle fender and the contoured surface, the gap protecting the surface of the motorcycle fender.

2. Size, shape, material and design may change for a different model. What is claimed is the concept of a load bearing bracket attached to the frame following the fender contour without making contact with the fender finish thus far unaccomplished without bracing to the rear axle:

3. A bracket for coupling an armrest seat back hereto, the bracket having a v-shaped configuration.

4. A bracket for coupling a sissy bar, the bracket having a v-shaped configuration.
